(19) United States
(12) Patent Application Publication
(10) Pub. No.: US 2007/0040153 A1
(43) Pub. Date: Feb. 22, 2007

(54) Film for anisotropic conductivity and electronic circuits and devices using the film

(76) Inventors: Ki Sung Jung, Ansan-Si (KR); Hyoun Young Kim, Siheung-Si (KR); Jong Hwa Lee, Siheung-Si (KR); Jung Sik Choi, Anyang-Si (KR); Jeong Ku Kang, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/388,380

(22) Filed: Mar. 23, 2006

(30) Foreign Application Priority Data
Aug. 19, 2005 (KR) 2005-76233

(51) Int. Cl. H01B 1/12

(52) U.S. Cl. 252/500

(57) ABSTRACT

Disclosed herein is a low-temperature fast-curable circuit connecting film for forming an anisotropic conductive film. The film includes a film-forming resin, a radical polymerizable material, a peroxide polymerization initiator, conductive particles, a transition metal. The transition metal activates the peroxide polymerization initiator. The circuit connecting material may be in a multi-layered structure, including: a first layer and a second layer formed on the first layer. The first layer includes, for example, a body-forming resin, a plurality of conductive particles, and a transition metal. The second layer includes, for example, a body-forming resin, a plurality of conductive particles, and a polymerization initiator.

### CROSS-REFERENCE TO RELATED APPLICATIONS

This application claims the benefit of Korean Patent Application No. 2005-76233, filed on Aug. 19, 2005 in the Korean Intellectual Property Office, the disclosure of which is incorporated herein by reference in its entirety.

### BACKGROUND OF THE INVENTION

1. Field of the Invention

The present invention relates to a film for forming an anisotropic conductive film.

2. Description of the Related Technology

Recently, an anisotropic conductive film has been widely used to electrically connect electronic components. An anisotropic conductive film is typically interposed between two electrodes and provides electrical connection between the two electrodes. For example, an anisotropic conductive film is interposed between a display pixel array and circuits facing the display pixel array.

### SUMMARY OF CERTAIN INVENTIVE ASPECTS

One aspect of the invention provides a circuit connecting material. The circuit connecting material comprises: a body-forming resin; a polymerizable compound; a plurality of conductive particles; a peroxide polymerization initiator; and a transition metal. The transition metal may comprise one or more selected from the group consisting of Ag, Co, Cr, Cu, Fe, Mo, Mn, Nb, Ni, Os, Pd, Rh, Ru, Sn, Ti, V, Y and Zn. The transition metal may be in at least one form selected from the group consisting of a salt, an ionic and a metal-ligand form.

The material may further comprise at least one transition-metal-containing compound selected from the group consisting of an oxide, an octate, a naphthenate, a halide, an acetylacetonate, a sulfate, a nitrate and a hydrate of a transition metal. The transition metal may be in an amount of between about 0.001 wt % and about 10 wt % with reference to the total weight of the material. The peroxide polymerization initiator may comprise a ketone peroxide. The transition metal may activate the peroxide polymerization initiator.

The material may further comprise an organic catalyst for controlling the polymerization rate of the polymerizable compound. The organic catalyst may comprise one or more selected from the group consisting of dimethylaniline, t-butylperoxy-2-ethylhexanoate, bis(4-t-butylcyclohexyl)peroxydicarbonate, nonylphenol, t-butylperbenzoate and quaternary ammonium.

The above described material may be shaped in a film. The film may be rolled into a reel. The material may further comprise an organic solvent, which dissolves at least part of the material and the material may be in a liquid or a slurry form.

Another aspect of the invention provides a circuit connecting material. The material comprises: a first layer comprising a transition metal, the first layer having a first surface; and a second layer formed on and in contact with the first surface, the second layer comprising a polymerization initiator, wherein at least one of the first and second layers further comprises at least one of a body-forming resin and conductive particles.

The first layer may be substantially free of a polymerization initiator. The first layer may further comprise a polymerization initiator in an amount substantially smaller than the polymerization initiator in the second layer. The second layer may comprise the polymerization initiator more than the first layer at least by 20 wt % of the polymerization initiator contained in the first layer. The second layer may be substantially free of a transition metal. The second layer may further comprise a transition metal in an amount substantially smaller than the transition metal in the first layer. The first layer may comprise the transition metal more than the second layer at least by 20 wt % of the transition metal contained in the second layer. The first layer may comprise at least one of the body-forming resin and the conductive particles. The second layer may comprise at least one of the body-forming resin and the conductive particles.

In the material, each of the first and the second layers may comprise the body-forming resin and conductive particles. The second layer may have a second surface facing away from the first layer and the material may further comprise a third layer formed on and in contact with the second surface. In addition, the third layer may comprise a transition metal.

Alternatively, the first layer may have a second surface facing away from the second layer and the material may further comprise a third layer formed on and in contact with the second surface. The third layer may comprise a polymerization initiator.

Yet another aspect of the invention provides a method of making an electronic device. The method comprises: providing an intermediate product of an electronic device, the intermediate product comprising first and second electrically conductive portions; placing the circuit connecting material described above between the first and second electrically conductive portions; anisotropically aligning at least some conductive particles between the first and second electrically conductive portions; and polymerizing at least part of the polymerizable compounds of the circuit connecting material, wherein the transition metal activates the peroxide polymerization initiator to initiate polymerization of the polymerizable compounds.

In the method, prior to placing the circuit connecting material, the circuit connecting material may be maintained at a temperature of less than about 10° C. The method may further comprise heating the circuit connecting material to a temperature from about 80° C. to about 200° C. after placing the circuit connecting material. Anisotropically aligning may comprise pressuring the circuit connecting material between the first and second electrically conductive portions.

Another aspect of the invention provides an electronic device made by the method described above. In the electronic device, the circuit connecting material is bonded to both the first and second electrically conductive portions and electrically connects between the first and second conductive portions.

Another aspect of the invention provides an electronic device comprising: a first circuit; a second circuit; and an anisotropic conductive film made from the circuit connecting material described above.

Yet another aspect of the invention provides an electronic device comprising: a first circuit; a second circuit; and an anisotropic conductive film interconnecting the first and second circuits, the anisotropic conductive film comprising at least one anisotropic conductive connection between the first and second circuits, a cross-linked polymer resin, a transition metal, and a peroxide polymerization initiator. The anisotropic conductive film may further comprise one or more compounds derived from the peroxide polymerization initiator. The transition metal may be generally homogeneously distributed in the anisotropic conductive film. The transition metal may be non-homogeneously distributed in the anisotropic conductive film. The anisotropic conductive film may comprise first and second layer-like portions, each of the layer-like portions extend generally perpendicular to a direction of the anisotropic conductive connection. The first layer-like portion may have substantially more transition metal than the second layer-like portion. The second layer-like portion may have substantially more peroxide polymerization initiator residue than the first layer-like portion.

### BRIEF DESCRIPTION OF THE DRAWINGS

FIG. 1 is a schematic cross-section illustrating a two-layered circuit connecting film in accordance with an embodiment of the invention.

FIG. 2 is a schematic cross-section illustrating a three-layered circuit connecting film in accordance with another embodiment of the invention.

FIG. 3 is a schematic cross-section illustrating a three-layered circuit connecting film in accordance with yet another embodiment of the invention.

### DETAILED DESCRIPTION OF EMBODIMENTS

Various aspects and features of the invention will become more fully apparent from the following description and appended claims taken in conjunction with the foregoing drawings. In the drawings, like reference numerals indicate identical or functionally similar elements.

An anisotropic conductive film is typically formed by curing a film-type circuit connecting material. The circuit connecting material includes a body-forming resin, a polymerizable compound, a polymerization initiator, and conductive particles. Typically, the film-type circuit connecting material is positioned between two electrodes. Then, a pressure is applied onto one electrode against the other while heating the film. During this process, conductive particles dispersed in the resin anisotropically align between the two electrodes and the polymerizable compound goes through polymerization initiated by the polymerization initiator. The polymerizable compound cross-links the body-forming resin. As such, electrical connection is established by the anisotropically-aligned conductive particles in the film, which is called anisotropic conductive film.

In a circuit connecting film material, the polymerizable compounds are typically thermosetting polymerizable compounds. Examples of a thermosetting resin made from thermosetting polymerizable compounds include epoxy resins and acryl resins. Epoxy thermosetting resins generally have good adhesion strength onto various surfaces and have high heat resistance and moisture resistance properties. However, epoxy resins require a high curing temperature and a long curing time. On the other hand, acryl thermosetting resins generally have a low curing temperature and a short curing time. However, the acryl resins do not have good adhesive strength, heat resistance, or moisture resistance.

Typically, an epoxy resin-containing anisotropic conductive film forming composition is cured at 200° C. for 8-15 seconds. An acryl resin-containing composition is cured at 180° C. for 8-12 seconds. Such a high temperature and a long curing time decrease the productivity of electronic part assembly. Further, during a high temperature (e.g., 367-420° C.) assembly process, a head tip of a bonder is thermally deformed. A “bonder,” as used herein, refers to an apparatus which is configured to press and heat a circuit connecting film to form an anisotropic conductive film. This problem may cause non-uniform bonding of the material into a surface. As a result, the product defect rate may increase.

As noted, one aspect of the invention provides a low-temperature fast-curable circuit connecting material. Reducing the time for curing the material will shorten the time for assembling electronic parts. Also, curing the material at a low temperature will minimize deformation of a bonder head tip during assembly processes.

### DEFINITIONS

The term “circuit connecting material,” as used herein, refers to a composition for forming an anisotropic conductive film (ACF). It may also be referred to as “anisotropic conductive film forming composition.” A circuit connecting material may be in a film form, and the material in a film form may be referred to as “circuit connecting film.” The term “anisotropic conductive film,” as used herein, refers to a film having at least one anisotropic electrical connection in the film.

Circuit Connecting Film

A circuit connecting film is a film-type composition for forming an anisotropic conductive film. A resulting anisotropic conductive film provides electric connection between electrodes.

In an embodiment, the circuit connecting film includes a body-forming resin; a polymerizable compound; a plurality of conductive particles; a peroxide polymerization initiator; and a transition metal. In other embodiments, the film further includes other additives such as an organic catalyst, a coupling agent, a polymerization inhibitor, an antioxidant, and a thermal stabilizer. In one embodiment, for example, the circuit connecting film includes about 5 wt % to about 75 wt % of a body-forming resin; about 5 wt % to about 75 wt % of a polymerizable compound, about 0.1 wt % to about 15 wt % of a peroxide polymerization initiator, about 0.01 wt % to about 30 wt % of conductive particles, and about 0.001 wt % to about 10 wt % of a transition metal. The compositional relations among the components may significantly vary in different embodiments.

In one embodiment, the circuit connecting film is formed from a composition including the components of the circuit connecting film described above and an organic solvent. The composition for forming circuit connecting film may be in a slurry form and applied onto a substrate to form a slurry layer. Then, the slurry layer is dried, and the organic solvent in the material is evaporated leaving a circuit connecting film. In certain embodiments, the slurry layer may be heated to facilitate evaporation of the solvent.

The peroxide polymerization initiator and the transition metal for use in the circuit connecting film will be described below. Details of the body-forming resin, the polymerizable compound, and other additives will be described later.

Peroxide Polymerization Initiator

In embodiments of the invention, the circuit connecting film includes a polymerization initiator. The polymerization initiator may be a radical polymerization initiator which generates a free radical upon activation, e.g., by heating. In one embodiment, a peroxide initiator is used as the polymerization initiator. In certain embodiments, a ketone-based peroxide is used to initiate polymerization of polymerizable compounds for polyester or vinyl ester resin.

Examples of the peroxide initiator include, but are not limited to, methylethylketone peroxide, dipercumyl peroxide, t-butylperoxylaurate, 1,1,3,3-tetramethylbutylperoxy-2-ethylhexanonate, 2,5-dimethyl-2,5-di(2-ethylhexanoylperoxy)hexane, t-butylhydroperoxide, 1-cyclohexyl-1-methylethylperoxy-2-ethylhexanonate, 2,5-dimethyl-2,5-di(m-toluoylperoxy)hexane, t-butylperoxyisopropylmonocarbonate, t-butylperoxy-2-ethylhexylmonocarbonate, t-hexylperoxybenzoate, t-butylperoxyacetate, α,α-bis(t-butylperoxy)diisopropylbenzene, dicumylperoxide, 2,5-dimethyl-2,5-di(t-butylperoxy)hexane, t-butylcumylperoxide, t-butylperoxyneodecanoate, t-hexylperoxy-2-ethylhexanonate, t-butylperoxy-2-2-ethylhexanonate, t-butylperoxyisobutyrate, 1,1-bis(t-butylperoxy)cyclohexane, t-hexylperoxyisopropylmonocarbonate, t-butylperoxy-3,5,5-trimethylhexanonate, t-butylperoxypivalate, cumylperoxyneodecanoate, diisopropylbenzenehydroperoxide, diisopropylbenzenehydroperoxide, cumene hydroperoxide, isobutylperoxide, 2,4-dichlorobenzoylperoxide, 3,5,5-trimethylhexanoylperoxide, octanoylperoxide, lauroylperoxide, stearoylperoxide, succinic peroxide, benzoylperoxide, 3,5,5-trimethylhexanoylperoxide, octanoylperoxide, benzoylperoxytoluene, benzoylperoxide, 1,1,3,3-tetramethylbutylperoxyneodecanoate, 1-cyclohexyl-1-methylethylperoxyneodecanoate, di-n-propylperoxydicarbonate, diisopropylperoxycarbonate, bis(4-t-butylcyclohexyl) peroxydicarbonate, di-2-ethoxymethoxyperoxydicarbonate, di(2-ethylhexylperoxy)dicarbonate, dimethoxybutylperoxydicarbonate, di(3-methyl-3-methoxybutylperoxy)dicarbonate, 1,1-bis(t-hexylperoxy)-3,3,5-trimethylcyclohexane, 1,1-bis(t-hexylperoxy)cyclohexane, 1,1-bis(t-butylperoxy)-3,3,5-trimethylcyclohexane, 1,1-(t-butylperoxy)cyclododecane, 2,2-bis(t-butylperoxy)decane, t-butyltrimethylsilylperoxide, bis(t-butyl)dimethylsilylperoxide, t-butyltriallylsilylperoxide, bis(t-butyl)diallylsilylperoxide, tris(t-butyl)allylsilylperoxide, etc.

In embodiments, the polymerization initiator is in an amount of between about 0.1 wt % and about 15 wt % with reference to the total weight of the circuit connecting film, optionally from about 1 wt % to about 7 wt % or from about 5 wt % to about 12 wt %.

Transition Metal

In one embodiment, the circuit connecting film includes a multivalent transition metal. The transition metal is to activate the peroxide polymerization initiator to generate a radical at a relatively low temperature, for example, from 10° C. to 100° C. One of ordinary skill in the art will appreciate temperatures or ranges of temperature at which the peroxide can be activated. In certain embodiments, the transition metal may activate a ketone-based peroxide.

Examples of the transition metal include, but are not limited to, Ag, Co, Cr, Cu, Fe, Mo, Mn, Nb, Ni, Os, Pd, Rh, Ru, Sn, Ti, V, Y, and Zn. The transition metal activates the peroxide polymerization initiator by decomposing the initiator. Although the invention is not bound to a theory, the transition metal ion is believed to activate a polymerization initiator in one of the following chemical mechanisms represented by Equations (1), (2), and (3) below.
R—O—O—H+M²⁺→R—O.+OH⁻M³⁺ Equation (1)
R—O—O—H+M³⁺→R—O—O.+H⁺M³⁺ Equation (2)
R—O.+M³⁺→R—O⁻+M³⁺ Equation (3)

The multivalent transition metal may be used in a metal-ligand, a salt and/or an ionic form to activate the peroxide initiator. The transition metal may be a part of a metal compound such as an oxide, an octate, a naphthenate, a halide, an acetylacetonate, a sulfate, a nitrate, or a hydrate of a metal. In the circuit connecting film, the metal ion may be dissociated from the metal compound and may exist in a free ionic form.

Examples of transition metal compounds include, but are not limited to, cobalt octate, copper octate, cobalt naphthenate, copper naphthenate, vanadium pentoxide, manganese naphthenate, palladium oxide, palladium halide, palladium acetate, titanium oxide, titanium acetate, titanium oxide acetylacetonate, vanadium oxide, vanadium acetate, vanadium acetylacetonate, rhodium oxide, rhodium acetate, rhodium acetate dimer, copper oxide, copper acetate, copper halide, zinc oxide, zinc acetate, zinc sulfate, zinc nitrate, zinc halide, iron oxide, iron halide, iron acetate, iron sulfate, iron nitrate, yttrium hexafluoroacetylacetonate, yttrium oxide, yttrium oxalate hydrate, molybdenum oxide, molybdenum acetate, molybdenum oxalate hydrate, molybdenum acetylacetonate, manganese oxide, and manganese acetylacetonate.

In embodiments, the transition metal is in an amount of between about 0.001 wt % and about 10 wt % with reference to the total weight of the circuit connecting film, optionally from about 0.01 wt % to about 8 wt % or from about 0.1 wt % to about 4 wt %.

Use of the Circuit Connecting Film

The circuit connecting film is used for forming an anisotropic conductive film. In embodiments, the circuit connecting film is first placed between two electrodes or circuits. When a sufficient pressure is applied onto one electrode against the other, the conductive particles are anisotropically aligned between the electrodes and establish electrical connection between the electrodes. The electrical connection is maintained by polymerizing polymerizable compounds and curing polymer materials in the film.

According to an embodiment of the invention, the polymerization and curing can be initiated at a low temperature. The transition metal in the film activates the peroxide polymerization initiator at a relatively low temperature as described above. As a result, without or before heating the circuit connecting film, the polymerization initiator may generate radicals, which can react with polymerizable compounds. This radical polymerization reaction also generates additional radicals, which react with other polymerizable compounds such that polymerization reactions continue. The resulting radical compounds may also react with a polymer formed through a series of radical reactions. Most of the resulting radical compounds, while participating in the polymerization process described above, also react with body-forming resins existing in the film and form cross-links between the body-forming resins. In one embodiment, the temperature for polymerization ranges between about 120° C. and about 200° C. In another embodiment, the temperature is between about 80° C. and about 180° C. A skilled artisan in this art will appreciate different polymerization reactions occurring at different temperature or ranges thereof.

In one embodiment, the circuit connecting film may be a single-layered film, including all the ingredients described as above. In other embodiments, to improve stability of the circuit connecting film and/or to improve controllability of the polymerization reaction, the circuit connecting film may be formed in a multi-layered structure. In embodiments, the circuit connecting film may be formed in two, three, four, five, six, seven, right, nine or more layers.

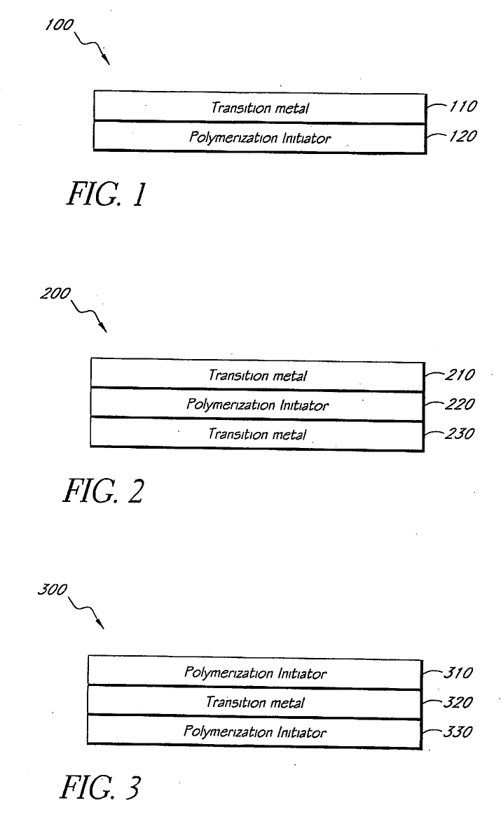

Referring to FIG. 1, a two-layer circuit connecting film 100 is described. In the illustrated embodiment, the circuit connecting film 100 includes a first layer 110 and a second layer 120 under the first layer 110. In another embodiment (not illustrated), the second layer may be positioned over the first layer. The first layer 110 contains a transition metal. In one embodiment, the first layer 110 is substantially free of a polymerization initiator. In other embodiments, the first layer 110 contains some polymerization initiator. The second layer 120 contains a polymerization initiator. In one embodiment, the second layer 120 is substantially free of a transition metal. In other embodiments, the second layer 120 contains some amount of transition metal. This configuration allows the circuit connecting film to be stable during storage or transportation.

The first and the second layers 110, 120 may further contain either or both of a body-forming resin and a plurality of conductive particles. In one embodiment, the first and the second layers 110, 120 may also include a polymerizable compound. In another embodiment, the first layer 110 includes a polymerizable compound whereas the second layer 120 is substantially free of a polymerizable compound.

The first layer 110 may have a thickness of between about 3 μm and about 50 μm, optionally between about 10 μm and about 30 μm. The second layer 120 may have a thickness of between about 3 μm and about 50 μm, optionally between about 10 μm and about 30 μm. The first and second layers 110, 120 may or may not have the same thickness. For example, the circuit forming film, either single- or multi-layered, has a thickness from about 10 μm to about 50 μm. A skilled artisan will appreciate that the thickness of the layers in a multi-layered film may significantly vary depending upon the components of each layer and other design factors.

With the two-layer construction, the circuit connecting film 100 may be more stable than single-layer circuit connecting films during storage or transportation. As explained above, the transition metal may activate the polymerization initiator at a relatively low temperature, when they contact each other. In the two-layer circuit connecting film 100, however, it is less likely that the transition metal contacts and activates the polymerizable initiator while the layered structures are maintained than in single-layer circuit connecting films.

In connecting circuits or manufacturing an electronic device, the two-layer circuit connecting film 100 is placed between opposing circuits and is subject to pressure and/or heat. When certain pressure is applied to the film 100, the border between the first layer 110 and the second layer 120 can be broken or become less tight, and the contents of the two layers 110 and 120 can be mixed together. As a result, the transition metal can more likely contact and activate the polymerization initiator than before application of such pressure. In one embodiment, the pressure may be applied to the film 100 unevenly, which can further the mixing of the contents of the two layers 110 and 120. Further, heating of the film 100 in addition to the pressure thereto may increase the likelihood of interlayer and/or intralayer migration of the transition metal and the polymerization initiator. This can bring more contacts between the transition metal and the polymerization initiator, and therefore activation of the polymerization initator. In addition, heating the film may further facilitate activation of the polymerization initiator because it provides thermal energy for the polymerization initiator to become activated. Once activated, the polymerization initiator will initiate polymerization of the polymerizable compounds existing in either or both of the layers, as described above in connection with the single-layer circuit connecting film.

In certain embodiments, a circuit connecting film may have three layers. Referring to FIG. 2, a circuit connecting film 200 having three layers is described. In the illustrated embodiment, the circuit connecting film 200 has first, second, and third layers 210, 220, 230, each of which may include one or more of a body-forming resin, a polymerizable compound, and conductive particles. The first layer 210 includes a transition metal. The first layer 210 may be substantially free of a polymerization initiator, although not limited thereto. The second layer 220 includes a polymerization initiator. The second layer 220 may be substantially free of a transition metal, although not limited thereto. The third layer 230 includes a transition metal. The third layer 230 may also be substantially free of a polymerization initiator, although not limited thereto. The first, second, and third layers 210, 220, 230 may or may not have the same thickness. As discussed, the thickness of each layer may significantly vary depending upon their components and other design factors.

In another embodiment shown in FIG. 3, a circuit connecting film 300 has first, second, and third layers 310, 320, 330, each of which may include one or more of a body-forming resin, a polymerizable compound, and conductive particles. The first and third layers 310 and 330 include a polymerization initiator and generally correspond to the second layer 220 of FIG. 2. The second 320 layer includes a transition metal and generally corresponds to the first or third layer 210 or 230 of FIG. 2.

In one embodiment, the multi-layered circuit connecting films described above may be prepared by the following method. First, a slurry or liquid containing components of a layer is applied on a surface to form a slurry or liquid layer thereon. A solvent is at least partially removed by drying the slurry or liquid layer to form a solid layer. Another layer of liquid or slurry is formed on the solid layer and dried to form another solid layer over the first solid layer. In another embodiment, two or more single layered films are laminated to provide a multi-layered circuit connecting film. A skilled artisan would appreciate that the methods can vary depending on the materials used for the circuit connecting film and other design factors.

Electronic Devices

Another aspect of the invention provides an electronic device including an anisotropic conductive film. In one embodiment, the electronic device includes a first circuit, a second circuit, and an anisotropic conductive film interconnecting the first and second circuits. The anisotropic conductive film includes at least one anisotropic conductive connection between electrodes of the circuits, a cross-linked polymer resin, a transition metal, and a peroxide polymerization initiator.

In one embodiment, the components of the anisotropic conductive film other than the conductive particles may be generally homogeneously distributed. An anisotropic conductive film formed from the multi-layered circuit connecting film may not be thoroughly homogeneous. For example, an anisotropic conductive film formed from the two-layer film 100 of FIG. 1 may have first and second layer-like portions which extend generally perpendicular to the anisotropic conductive connection. The first layer-like portion generally originates from the first layer 110, and the second layer-like portion generally originates from the second layer 120. As the polymerization reaction is carried out in the manufacturing process of the electronic device, the boundary between the first and second layers 110 and 120 becomes blurry. As a result, the first and second layer-like portions of the anisotropic conductive film do not have a definite/clear border between them. The first layer-like portion has substantially more transition metal than the second layer-like portion. The second layer-like portion has substantially more peroxide polymerization initiator and its residues than the first layer-like portion.

The electronic device may include, but is not limited to consumer electronic products, electronic circuits, electronic circuit components, parts of the consumer electronic products, electronic test equipments, etc. The consumer electronic products may include, but are not limited to, a mobile phone, a telephone, a television, a computer monitor, a computer, a hand-held computer, a personal digital assistant (PDA), a microwave, a refrigerator, a stereo system, a cassette recorder or player, a DVD player, a CD player, a VCR, an MP3 player, a radio, a camcorder, a camera, a digital camera, a portable memory chip, a washer, a dryer, a washer/dryer, a copier, a facsimile machine, a scanner, a multi functional peripheral device, a wrist watch, a clock, etc. Further, the electronic device may include unfinished products.

In one embodiment, the electronic device described above may be made by the following method. First, a first part of an electronic device having a first electrode is provided. Then, a circuit connecting film is provided onto the first part to cover the first electrode. Next, a second part of the electronic device having a second electrode is provided over the first part. The second part is positioned so that the second electrode is aligned above the first electrode with the circuit connecting film interposed between the electrodes. Then, pressure is applied onto the second part against the first part. In addition, heat may be applied to the circuit connecting film. In certain embodiments, the circuit connecting material may be pressed and/or heated to a temperature of between about 60° C. and about 160° C. for about 0.5 to about 2 seconds before being provided between the electrodes.

During this process, the conductive particles are self-aligned between the electrodes and provide anisotropically electric connection between the electrodes. In addition, the polymerization initiator initiates polymerization of the polymerizable compound. As a result, cross-links are formed between the body-forming resins. Since the polymerizable compounds generate thermosetting polymers and cross-links, the anisotropic electric connection maintains as the thermosetting polymers cure. This configuration maintains the established electrical connection between the electrodes of the electronic device.

Now, other components for use in the circuit connecting film will be described below in detail.

Body-Forming Resin

The body-forming resin forms the body or structure of the circuit connecting film. The body-forming resin may also be referred to as a “binder” or “film-forming resin.” In one embodiment, the body-forming resin is primarily a thermoplastic resin. In another embodiment, the body-forming resin may further contain a thermosetting resin. In another embodiment, the body-forming resin may be a thermosetting resin. In certain embodiments, a circuit connecting film may further include an elastomeric resin.

Examples of resin for use as a body-forming resin includes a phenol resin, an epoxy resin, a phenoxy resin, a polyester resin or a mixture thereof. The body-forming resin may include, as a repeating moiety, a substituent group derived from hydroquinone, 2-bromohydroquinone, resorcinol, catechol, bisphenol A, bisphenol F, bisphenol AD, bisphenol S, 4,4′-dihydroxybiphenyl, bis(4-hydroxyphenyl)ether, phenol, cresol, cresol novolac, fluorene, or the foregoing compounds substituted with one or more substituent groups.

The substituted phenol may be substituted with one or more substituent groups selected from linear or branched C1-C5 alkyl, halogen-substituted linear or branched C1-C5 alkyl, nitro-substituted linear or branched C1-C5 alkyl, aryl, halogen-substituted aryl, nitro-substituted aryl, methylol, halogen-substituted methylol, nitro-substituted methylol, allyl, halogen-substituted allyl, nitro-substituted allyl, alicyclic, halogen-substituted alicyclic, nitro-substituted alicyclic, linear or branched C1-C5 alkoxycarbonyl, halogen-substituted linear or branched C1-C5 alkoxycarbonyl, and nitro-substituted linear or branched C1-C5 alkoxycarbonyl.

In addition, where the phenol is bisphenol A, bisphenol F, bisphenol AD, or bisphenol S substituent groups, one or more non-benzene-ring carbon atoms of the bisphenols may be substituted with a substituent group selected from linear or branched C1-C5 alkyl, allyl, alicyclic, or linear or branched C1-C5 alkoxycarbonyl.

The phenol and phenoxy resins described above may be obtained by introducing an alkyl group, an aryl group, a methylol group, an allyl group, an alicyclic group, halogen, or a nitro group to the backbone of hydroquinone, 2-bromohydroquinone, resorcinol, catechol, bisphenol A, bisphenol F, bisphenol AD, bisphenol S, 4,4′-dihydroxybiphenyl, bis(4-hydroxyphenyl)ether, a phenol group, a cresol group, a cresol novolac group, and a fluorene group. A linear or branched alkyl group, an allyl group, a substituted allyl group, an alicyclic group, or an alkoxycarbonyl group may be introduced to one or more non-benzene ring carbon atoms of the bisphenols.

For example, the substituted or unsubstituted phenol includes 4,4′-(1-methylethylidene)bis[2-methylphenol], 4,4′-methylenebis[2-methylphenol], 4,4′-(1-methylethylidene)bis[2-(1-methylethyl)phenol], 4,4′-(1-methylethylidene)bis[2-(1,1-methylpropyl)phenol], 4,4′-(1-methylethylidene)bis[2-(1,1-dimethylethyl)phenol], tetramethylbisphenol A, tetramethylbisphenol F, 4,4′-methylenebis[2,6-bis(1,1-dimethylethyl)phenol], 4,4′-(1-methylethylidene)bis[2,6-di(1,1-dimethylethyl)phenol], 4,4′-(1-methylethylidene)bis[2-(2-propenyl)phenol], 4,4′-methylenebis[2-(2-prophenyl)phenol], 4,4′-(1-methylethylidene)bis[2-(1-phenylethyl)phenol], 3,3′-dimethyl[1,1′-biphenyl]-4,4′-diol, 3,3′,5,5′-tetramethyl-[1,1′-biphenyl]-4,4′-diol, 3,3′,5,5′-tetra-t-butyl-[1,1′-biphenyl]-4,4′-diol, 3,3′-bis(2-propenyl)-[1,1′-biphenyl]-4,4′-diol, 4,4′-(1-methylethylidene)bis[2-methyl-6-hydroxymethylphenol], tetramethylolbisphenol A, 3,3′,5,5′-tetrakis(hydroxymethyl)-(1,1′-biphenyl)-4,4′-diol, 4,4′-(1-methylethylidene)bis[2-phenylphenol], 4,4′-(1-methylethylidene)bis[2-cyclohexylphenol], 4,4′-methylenebis (2-cyclohexyl-5-methylphenol), 4,4′-(1-methylpropylidene)bisphenol, 4,4′-(1-methylheptylidene)bisphenol, 4,4′-(1-methyloctylidene)bisphenol, 4,4′-(1,3-dimethylbutylidene)bisphenol, 4,4′-(2-ethylhexylidene)bisphenol, 4,4′-(2-methylpropylidene)bisphenol, 4,4′-propylidene bisphenol, 4,4′-(1-ethylpropylidene)bisphenol, 4,4′-(3-methylbutylidene)bisphenol, 4,4′-(1-phenylethylidene)bisphenol, 4,4′-(phenylmethylene)bisphenol, 4,4′-(diphenylmethylene)bisphenol, 4,4′-[1-(4-nitrophenyl)ethylidene]bisphenol, 4,4′-[1-(4-aminophenyl)ethylidene]bisphenol, 4,4′-[(4-bromophenyl)methylenebisphenol, 4,4′-[(4-chlorophenyl)methylenebisphenol, 4,4′-[(4-fluorophenyl)methylenebisphenol, 4,4′-(2-methylpropylidene)bis[3-methyl-6-(1,1-dimethylethyl)phenol, 4,4′-(1-ethylpropylidene)bis[2-methylphenol], 4,4′-(1-phenylethylidene)bis[2-methylphenol], 4,4′-(phenylmethylene)bis-2,3,5-trimethylphenol, 4,4′-(1-phenylethylidene)bis[2-(1,1-dimethylethyl)phenol], 4,4′-(1-methylpropylidene)bis[2-cyclohexyl-5-methylphenol], 4,4′-(1-phenylethylidene)bis[2-phenylphenol], 4,4′-butylidenebis[3-methyl-6-(1,1-dimethylethyl)phenol], 4-hydroxy-α-(4-hydroxyphenyl-α-methylbenzene acetylene methyl ester, 4-hydroxy-α-(4-hydroxyphenyl-α-methylbenzene acetylene ethyl ester, 4-hydroxy-α-(4-hydroxyphenyl)benzene acetylene butyl ester, tetrabromobisphenol A, tetrabromobisphenol F, tetrabromobisphenol AD, 4,4′-(1-methylethylene)bis[2,6-dichlorophenol], 4,4′-(1-methylethylidene)bis[2-chlorophenol], 4,4-(1-methylethylidene)bis[2-chloro-6-methylphenol], 4,4′-methylenebis[2-fluorophenol], 4,4′-methylenebis[2,6-difluorophenol], 4,4′-isopropylidenebis[2-fluorophenol], 3,3′-difluoro-[1,1′-diphenyl]-4,4′-diol, 3,3′,5,5′-tetrafluoro-[1,1′-biphenyl]-4,4′-diol, 4,4′-(phenylmethylene)bis[2-fluorophenol], 4,4′-[(4-fluorophenyl)methylenebis[2-fluorophenol], 4,4′-(fluoromethylene)bis[2,6-difluorophenol], 4,4′-(4-fluorophenyl)methylenebis[2,6-difluorophenol], 4,4′-(diphenylmethylene)bis[2-fluorophenol], 4,4′-(diphenylmethylene)bis[2,6-difluorophenol], 4,4′-(1-methylethylene)bis[2-nitrophenol], 1,4-naphthalenediol, 1,5-naphthalenediol, 1,6-naphthalenediol, 1,7-naphthalenediol, 2,7-naphthalenediol, 4,4′-dihydroxydiphenylether, bis(4-hydroxyphenyl)methanone, 4,4′-cyclohexylidenebisphenol, 4,4′-cyclohexylidenebis[2-methylphenol], 4,4′-cyclopentylidenebisphenol, 4,4′-cyclopentylidenebis[2-methylphenol], 4,4′-cyclohexylidene[2,6-dimethylphenol], 4,4′-cyclohexylidenebis[2-(1,1-dimethylethyl)phenol], 4,4′-cyclohexylidenebis[2-cyclohexylphenol], 4,4′-(1,2-ethanediyl)bisphenol, 4,4′-cyclohexylidenebis[2-phenylphenol], 4,4′-[1,4-phenylenebis(1-methylethylidene)]bis[2-methylphenol], 4,4′-[1,3-phenylenebis(1-methylethylidene)]bisphenol, 4,4′-[1,4-phenylenebis(1-methylethylidene)]bisphenol, 4,4′-[1,4-phenylenebis(1-methylethylidene)]bis[2-methyl-6-hydroxymethylphenol], 4-[1-[4-(4-hydroxy-3-methylphenyl)-4-methylcyclohexyl]-1-methylethyl]-2-methylphenol, 4-[1-(4-hydroxy-3,5-dimethylphenyl)-4-methylcyclohexyl]-1-methylethyl]-2,6-dimethylphenol, 4,4′-(1,2-ethanediyl)bis[2,6-di-(1,1-dimethylethyl)phenol], 4,4′-(dimethylsilylene)bisphenol, 1,3-bis(p-hydroxyphenyl)-1,1,3,3-tetramethyldisiloxane, and a silicone oligomer having p-hydroxyphenyl groups at both terminals thereof.

Further, the substituted or unsubstituted phenol may be a phenolic substituent group obtained by introducing a linear or branched C1-C5 alkyl group, an aryl group, a methylol group, or an allyl group to one or more benzene rings of 2,2′-methylidenebisphenol, 2,2′-methylethylidenebisphenol, or 2,2′-ethylidenebisphenol. The phenolic substituent group includes, for example, 2,2′-methylidenebis[4-methylphenol], 2,2′-ethylidenebis[4-methylphenol], 2,2′-methylidenebis[4,6-dimethylphenol], 2,2′-(1-methylethylidene)bis[4,6-dimethylphenol], 2,2′-(1-methylethylidene)bis[4-sec-butylphenol], 2,2′-methylidenebis[6-(1,1-dimethylethyl)-4-methylphenol], 2,2′-ethylidenebis[4,6-di(1,1-dimethylethyl)phenol], 2,2′-methylidenebis[4-nonylphenol], 2,2′-methylidenebis[3-methyl 4,6-di-(1,1-dimethylethyl)phenol], 2,2′-(2-methylpropylidene)bis[2,4-dimethylphenol], 2,2′-ethylidenebis[4-(1,1-dimethylethyl)phenol], 2,2′-methylidenebis(2,4-di-t-butyl-5-methylphenol), 2,2′-methylidenebis(4-phenylphenol), 2,2′-methylidenebis[4-methyl-6-hydroxymethylphenol], 2,2′-methylenebis[6-(2-propenyl)phenol], etc. More examples of the body-forming resin are disclosed in U.S. patent application Ser. No. 11/273,160, which is incorporated herein by reference.

In one embodiment, the body-forming resin has a high glass transition temperature of between about 0° C. and about 200° C. The body-forming resin may have a weight average molecular weight of about 10,000 or less. In one embodiment, the body-forming resin is in an amount from about 10 wt % to 60 wt % with reference to the total weight of the circuit connecting film. One of ordinary skill in the art will appreciate appropriate amounts of the body-forming resin in view of other components and desired properties of the circuit connecting film and anisotropic conductive film.

In certain embodiments, the circuit connecting film may further include an elastomeric resin. The elastomeric resin provides elasticity to a resulting anisotropic conductive film. The elastomeric resin may be a rubber with a carboxyl or epoxy group. Examples of the elastomeric resin include acrylonitrile-, butadiene-, styrene-, acryl-, isoprene-, ethylene-, propylene-, and silicone-based rubbers. The elastomeric resin may have a weight average molecular weight of between about 500 and 5,000,000, optionally between about 30,000 and about 1,500,000. In one embodiment, the elastomeric resin is in an amount of between about 5 wt % and about 75 wt % with reference to the total weight of the circuit connecting film. One of ordinary skill in the art will appreciate appropriate amounts of elastomeric resin in view of other components and desired elasticity of the circuit connecting film and anisotropic conductive film.

Polymerizable Compound

According to embodiments of the invention, the circuit connecting film includes a polymerizable compound. The polymerizable compound provides a cross-link between the body-forming resins. The polymerizable compound may be referred to as a “cross-linking agent.” In some embodiments, the polymerizable compound may be a monomer or oligomer for a thermosetting polymer or a thermosetting polymer which can further polymerize. The polymerizable compound may be at least one radical polymerizable compound selected from acrylate- or methacrylate-based monomer or oligomer. Certain oligomers and thermosetting polymers that can be used as the radical polymerizable compound may have a weight average molecular weight ranging from about 500 to about 100,000.

In one embodiment, the radical polymerizable compound is an urethane acrylate oligomer having a weight average molecular weight ranging from about 1,000 to about 100,000. In one embodiment, the urethane acrylate oligomer is represented by Formula 1 below:

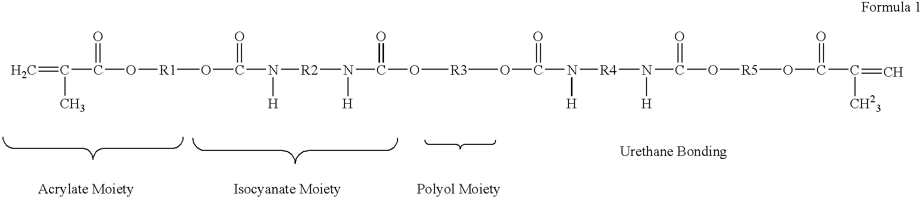

In Formula 1, R1 may be an organic group containing hydroxyl functionality to react with an isocynate group such as hydroxyethyl, hydroxypropyl, hydroxybutyl, grycerin, or propyl-3-acryloyloxy moiety. R2 may be 2,4-toluene diisocyanate, 1,3-xylene diisocyanate, 1,4-xylene diisocyanate, 1,5-naphthalene diisocyanate, 1,6-hexane diisocyanate, or isophorone diisocyanate. R3 may be polyester polyol, polyether polyol, polycarbonate polyol, polycarprolactone polyol, tetrahydrofurane-propyleneoxide which is ring-opened copolymer, polybutadiene diol, polydimethylsiloxane diol, ethylene glycol, propylene glycol, 1,4-butanediol, 1,5-pentanediol, 1,6-hexanediol, neopentyl glycol, 1,4-cyclohexane dimethanol, bisphenol A, hydrogenated bisphenol A. R4 may be the same as R₂. R5 may be the same as R₁.

In another embodiment, an epoxy acrylate oligomer may be used as a polymerizable compound. The epoxy acrylate oligomer may have a weight average molecular weight ranging from about 500 to about 30,000. In one embodiment, the epoxy acrylate is represented by Formula 2 below:

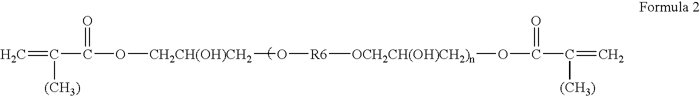

In Formula 2, R6 may be 2-bromohydroquinone, resorcinol, catechol, bisphenol, phenol, cresol, a cresol novolac, fluorine. The bisphenol may be. bisphenol A, bisphenol F, bisphenol AD, or bisphenol S, 4,4′-dihydroxybiphenyl, bis(4-hydroxyphenyl)ether. The foregoing may be substituted with a substituted or unsubstituted, linear or branched C1-C5 alkyl group, an aryl group, an acrylalkyl group, a methylol group, an allyl group, an alicyclic group, halogen, or a nitro group. The alkyl group may be substituted with linear, cyclohexyl, isobornyl, tricyclodecane, and hydrogenated bispheyl of hydrogenated bisphenol A. The aryl group may be selected from phenyl, biphenyl, triphenyl and naphtyl.

In other embodiments, the radical polymerizable material may be a (meth)acrylate monomer. The (meth)acrylate monomer may contain a hydroxyl group, an epoxy group or a carboxyl group.

Examples of the (meth)acrylate monomer having a hydroxyl group include, but are not limited to, 2-hydroxyethyl(meth)acrylate, 2-hydroxypropyl(meth)acrylate, 2-hydroxybutyl(meth)acrylate, 2-hydroxy-3-acroyloxypropyl(meth)acrylate, 1-hydroxybutyl(meth)acrylate, polycarprolactone polyol mono(meth)acrylate, 2-hydroxy-3-phenyloxypropyl(meth)acrylate, 2-hydroxy-3-phenoxypropylacrylate, 2-acryloyloxyethyl 2-hydroxy ethylphthalate, and di(meth)acrylate based bisphenol A (e.g.: EB-600, available from SK-UCB, Korea).

Examples of the (meth)acrylate monomer containing an epoxy group include glycidyl (meth)acrylate, methylglycidyl (meth)acrylate, and (meth)acrylate containing alicyclic epoxy (e.g., M100 or A200, available from Daicel Chemical Industries, Ltd., Japan). Examples of the (meth)acrylate monomer containing a carboxy group include 2-methacryloyloxyethylhexahydrophthalate, and 2-methacryloyloxyethylsuccinate.

To control the viscosity, the circuit connecting film may include a (meth)acrylate monomer as a polymerizable compound. Examples of (meth)acrylate include neopentylglycol mono(meth)acrylate, 1,6-hexanediolmono(meth)acrylate, pentaerythritol penta(meth)acrylate, dipentaerythritol penta(meth)acrylate, glycerin di(meth)acrylate, tetrahydrofurfuryl(meth)acrylate, isodecyl(meth)acrylate, 2-(2-ethoxyethoxy)ethyl(meth)acrylate, stearyl(meth)acrylate, lauryl(meth)acrylate, 2-phenoxyethyl(meth)acrylate, isobonyl(meth)acrylate, tridecyl(meth)acrylate, ethoxylated nonylphenol(meth)acrylate, ethyleneglycoldi(meth)acrylate, diethyleneglycoldi(meth)acrylate, triethyleneglycol di(meth)acrylate, tetraethyleneglycol di(meth)acrylate, polyethyleneglycol di(meth)acrylate, 1,6-hexanediol di(meth)acrylate, 1,3-butyreneglycol di(meth)acrylate, tripropyleneglycol di(meth)acrylate, ethoxylated bisphenol AD (meth)acrylate, cyclohexanedimethanol di(meth)acrylate, phenoxytetraethyleneglycol (meth)acrylate, 2-hydroxyethylmethacryloyloxyethylphosphate, 2-methacryloyloxyethylphosphate, dimethyloltricyclodecane di(meth)acrylate, dipentaerythritol hexaacrylate, trimethylopropanebenzoate acrylate, and a mixture thereof. More examples of the polymerizable compound are disclosed in U.S. patent application Ser. No. 11/273,160, which is incorporated herein by reference.

In one embodiment, the radical polymerizable material is in an amount of between about 5 wt % and about 75 wt % with reference to the total weight of the circuit connecting film. One of ordinary skill in the art will appreciate appropriate amounts of polymerizable compound in view of the other components and desired properties of the anisotropic conductive film.

Conductive Particles

The circuit connecting film also includes a plurality of conductive particles. The conductive particles can be made of a number of different materials such as metals including Al, Au, Ag, Ni, Cu, alloys of various metals, solder, carbon, etc. In some embodiments, the conductive particles may be inorganic or organic particles coated with a conductive material. The conductive coating material may be conductive metals including gold and silver. In another embodiment, the metal-coated conductive particles are further coated with an insulating material.

In one embodiment, the average particle size may be between about 2 to about 30 μm. The skilled artisans will be able to choose an appropriate size of the particles, depending on the dimensions of the circuit. In one embodiment, the circuit connecting film includes the conductive particles in an amount of about 0.01 wt % to about 50 wt % with reference to the total weight of the circuit connecting film. In other embodiments, the conductive particles are in an amount from about 1 wt % to about 20 wt %, optionally from about 3 wt % to about 15 wt % with reference to the total weight of the circuit connecting film.

Organic Catalyst

In certain embodiments, the circuit connecting film further includes an organic catalyst. The organic catalyst is used to control the polymerization rate of the polymerizable compound. Examples of the organic catalyst include dimethylaniline, t-butylperoxy-2-ethylhexanoate, bis(4-t-butylcyclohexyl)peroxydicarbonate, nonylphenol, t-butylperbenzoate, and quaternary ammonium. In one embodiment, the organic catalyst is in an amount of between about 0.001 wt % and about 3 wt % with reference to the total weight of the circuit connecting film, optionally between about 0.05 wt % and about 1.0 wt %.

Other Additives

Additionally, the circuit connecting film may include other additives such as a coupling agent, a polymerization inhibitor, an antioxidant, and/or a thermal stabilizer.

The coupling agent functions as an adhesion enhancer to increase the adhesive strength between components of the circuit connecting film and to prevent phase separation. In one embodiment, the homogenizer is a silane coupling agent. Examples of the silane coupling agent include (3-acryloxypropyl)methyldimethoxysilane, (3-acryloxypropyl)triethoxysilane, methacrylamidopropyl triethoxysilane), N-(3-methacryloxy-2-hydroxypropyl)-3-aminopropyltriethoxysilane, (methacryloxymethyl)bis(trimethylsiloxy)methylsilane, (methacryloxymethyl)dimethylethoxysilane, methacryloxymethyltriethoxysilane, methacryloxymethyltriethoxysilane, methacryloxypropyl diethylmethoxysilane, methacryloxypropylmethyldiethoxysilane, methacryloxypropylmethyldimethoxysilane, methacryloxypropyl triethoxysilane, methacryloxypropyltrimethoxysilane, and a mixture thereof. In one embodiment, the silane coupling agent is in an amount of between about 0.01 wt % to about 10 wt % with reference to the total weight of the circuit connecting film, optionally between about 0.2 wt % and about 3 wt %.

The polymerization inhibitor prevents unwanted polymerization reactions in the circuit connecting film, for example, during storage or transportation. Examples of the polymerization inhibitor include hydroquinone, hydroquinone monomethylether, p-benzoquinone, phenotiazine, and a mixture thereof.

The antioxidant prevents heat-induced oxidation of various components of the circuit connecting film. Examples of the antioxidants include branched phenolic and hydroxy cinnamate antioxidants. Certain antioxidants provide the material with heat stability as well as antioxidative activity. The antioxidant for use in the material includes, for example, tetrakis-(methylene-(3,5-di-tetrabutyl-4-hydrocinnamate)methane), 3,5-bis(1,1-dimethylethyl)-4-hydroxybenzenepropanoic acid thiodi-2,1-ethanediyl ester, octadecyl 3,5-di-(tert)-butyl-4-hydroxyhydrocinnamate, each of which is available from Cibageigy, 2,6-di-tert-butyl-p-methylphenol, 4-tert-butylcatechol, and a mixture thereof.

The thermal stabilizer provides thermal stability to the circuit connecting film. Examples of the thermal stabilizer include 2,6-di-tert-butyl-p-methylphenol and 4-tert-butylcatechol. The other additives including the polymerization inhibitor, the antioxidant, and/or the thermal stabilizer, may be in a total amount of between about 0.01 wt % and about 10 wt % with reference to the total weight of the circuit connecting film, optionally between about 0.05 wt % and about 2.0 wt %.

Organic Solvent

The circuit connecting film described above may be formed from the circuit connecting material including a solvent. In one embodiment, the circuit connecting material includes a solvent which dissolves at least part of the components for the circuit connecting film described above. The material is in the form of liquid or a mixture of liquid and solid components like slurry. In one embodiment, the solvent is an organic solvent. The organic solvent decreases the viscosity of the circuit connecting material so as to easily fabricate a film and facilitates uniform dispersion of the components of the material. Examples of the organic solvent include toluene, xylene, propylene glycol monomethyl ether acetate, benzene, acetone, methylethylketone, tetrahydrofuran, dimethylformaldehyde, cyclohexanone, etc.

A better understanding of the invention may be obtained in light of the following examples which are set forth to illustrate, but are not to be construed to limit the invention.

### EXAMPLE 1

A composition for a base film (base film composition B) was prepared as follows. A 1 L cylindrical flask was provided with a stirring rod. The flask was loaded with 200 g of 25 wt % acrylonitrile butadiene-based natural rubber (N-34, available from Nippon Zeon Co. Ltd., Japan) dissolved in toluene, 110 g of 35 wt % cresol novolac type epoxy resin (YDCN-500-90P, available from Kukdo Chemical Co. Ltd., Korea, Mw: 10,000 or less) dissolved in toluene, 0.5 g of manganese naphthenate, 5 g of conductive particles (available from NCI) having a diameter of 4 μm and having benzoguanine polymer particles coated with nickel and gold, and 1.0 g of 3-methacryloxypropyltriethoxysilane. The mixture was stirred at room temperature (25° C.) for 40 min.

Then, 5 g of 2-methacryloyloxyethylphosphate, 7 g of 2-hydroxyethylmethacryloyloxyethylphosphate, 50 g of difunctional isocyanourate type acrylate (M-215, available from Toagosei Co. Ltd., Japan) containing a hydroxy group, and 100 g of bisphenol A type epoxy acrylate (EB-600, available from SK-UCB, Korea) serving as a radical polymerizable acrylate-based monomer, 0.2 g of hydroquinone monomethylether as a polymerization inhibitor, and 100 g of propyleneglycol monomethyl ether acetate as a solvent were added. The mixture was stirred at room temperature (25° C.) for 30 min to prepare the base film composition B.

Another composition for a cover film (cover film composition C) was prepared as follows. A 1 L cylindrical flask was equipped with a stirring rod. The flask was loaded with 200 g of 25 wt % acrylonitrile butadiene based natural rubber (N-34, available from Nippon Zeon Co. Ltd., Japan) dissolved in toluene, 110 g of 35 wt % cresol novolac type epoxy resin (YDCN-500-90P, available from Kukdo Chemical Co. Ltd., Korea, Mw: 10,000 or less) dissolved in toluene, 10 g of conductive particles (available from NCI) having a diameter of 4 μm and having benzoguanine polymer particles coated with nickel and gold, 3 g of benzoyl peroxide (Chemex-BO, available from Hosung Chemex, Korea), 5 g of cumenhydroperoxide (available from NOF Corporation, Japan), and 1.0 g of 3-methacryloxypropyltriethoxysilane. The mixture was then stirred at room temperature (25° C.) for 40 min.

Subsequently, 5 g of 2-methacryloyloxyethylphosphate, 7 g of 2-hydroxyethylmethacryloyloxyethylphosphate, 50 g of difunctional isocyanourate type acrylate (M-215, available from Toagosei Co. Ltd., Japan) containing a hydroxy group, and 100 g of bisphenol A type epoxy acrylate (EB-600, available from SK-UCB, Korea), serving as a radical polymerizable acrylate monomer, 0.2 g of hydroquinone monomethylether as a polymerization inhibitor, and 100 g of propyleneglycol monomethyl ether acetate as a solvent were added. Then, the mixture was stirred at room temperature (25° C.) for 30 min, to prepare the cover film composition C.

Subsequently, the composition B was applied in a thickness of 10 μm onto a 50 μm-thick white PET type base film. The composition C was applied in a thickness of 10 μm onto a 30 μm-thick transparent PET type cover film. The resulting films were attached to each other and were laminated.

### EXAMPLE 2

A base film composition (composition B) was prepared as follows. A 1 L cylindrical flask was equipped with a stirring rod. The flask was loaded with 200 g of 25 wt % acryl rubber (KLS-1035DR, available from Fujikura Shoji Co. Ltd., Japan) dissolved in toluene, 110 g of 35 wt % cresol novolac type epoxy resin (YDCN-500-90P, available from Kukdo Chemical Co. Ltd., Korea, Mw: 10,000 or less) dissolved in toluene, 0.5 g of copper naphthenate, 0.1 g of dimethylaniline as an organic catalyst, 5 g of conductive particles (available from NCI) having a diameter of 4 μm and having benzoguanine polymer particles coated with nickel and gold, and 1.0 g of 3-methacryloxypropyltriethoxysilane as a radical polymerization silane coupling agent. The mixture was then stirred at room temperature (25° C.) for 40 min.

Thereafter, 5 g of 2-methacryloyloxyethylphosphate, 7 g of 2-hydroxyethylmethacryloyloxyethylphosphate, 50 g of trifunctional isocyanourate type acrylate (M-315, available from Toagosei Co. Ltd., Japan), and 100 g of bisphenol A type epoxy acrylate (EB-3701, available from SK-UCB, Korea), serving as a radical polymerizable acrylate monomer, 0.2 g of hydroquinone monomethylether as a polymerization inhibitor, and 100 g of propyleneglycol monomethyl ether acetate as a solvent were added and then the mixture was stirred at room temperature (25° C.) for 30 min to prepare the composition B.

A cover film composition (composition C) was prepared as follows. A 1 L cylindrical flask was equipped with a stirring rod. The flask was loaded with 200 g of 25 wt % acrylonitrile butadiene based natural rubber (N-34, available from Nippon Zeon Co. Ltd., Japan) dissolved in toluene, 110 g of 35 wt % cresol novolac type epoxy resin (YDCN-500-90P, available from Kukdo Chemical Co. Ltd., Korea, Mw: 10,000 or less) dissolved in toluene, 10 g of conductive particles (available from NCI) having a diameter of 4 μm and having benzoguanine polymer particles coated with nickel and gold, 8 g of benzoyl peroxide (available from Hosung Chemex, Korea), and 1 g of 3-methacryloxypropyltriethoxysilane as a radical polymerization silane coupling agent. The mixture was stirred at room temperature (25° C.) for 40 min.

Subsequently, 5 g of 2-methacryloyloxyethylphosphate, 7 g of 2-hydroxyethylmethacryloyloxyethylphosphate, 50 g of trifunctional isocyanourate type acrylate (M-315, available from Toagosei Co. Ltd., Japan), and 100 g of bisphenol A type epoxy acrylate (EB-3701, available from SK-UCB, Korea), serving as a radical polymerizable acrylate monomer, 0.2 g of hydroquinone monomethylether as a polymerization inhibitor, and 100 g of propyleneglycol monomethyl ether acetate as a solvent were added and then the mixture was stirred at room temperature (25° C.) for 30 min, to prepare the composition C.

Subsequently, the composition B was applied in a thickness of 10 μm onto a 50 μm-thick white PET type base film. The composition C was applied in the same thickness onto a 30μm-thick transparent PET type cover film. The resulting films were attached to each other, and were laminated.

### EXAMPLE 3

A base film composition (composition B) was prepared as follows. A 1 L cylindrical flask was equipped with a stirring rod. The flask was loaded with 200 g of 25 wt % acrylonitrile butadiene based natural rubber (N-34, available from Nippon Zeon Co. Ltd., Japan) dissolved in toluene, 110 g of 50 wt % fluorene type epoxy resin (BPEFG, available from Osaka Gas Co. Ltd., Japan, Mw: 500 or less) dissolved in toluene, 0.5 g of cobalt naphthenate, 0.1 g of dimethylaniline as an organic catalyst, 5 g of conductive particles (available from NCI) having a diameter of 4 μm and having benzoguanine polymer particles coated with nickel and gold, and 1.0 g of 3-methacryloxypropyltriethoxysilane as a radical polymerization silane coupling agent. The mixture was stirred at room temperature (25° C.) for 40 min.

Thereafter, 5 g of 2-methacryloyloxyethylphosphate, 7 g of 2-hydroxyethylmethacryloyloxyethylphosphate, 50 g of difunctional isocyanourate type acrylate (M-215, available from Toagosei Co. Ltd., Japan) containing a hydroxyl group, and 100 g of urethane acrylate (UA-512, available from Shin-Nakamura Chemical Co. Ltd., Japan), serving as a radical polymerizable acrylate monomer, 0.2 g of hydroquinone monomethylether as a polymerization inhibitor, and 100 g of propyleneglycol monomethyl ether acetate as a solvent were added. Then, the mixture was stirred at room temperature (25° C.) for 30 min, to prepare the composition B.

A cover film composition (composition C) was prepared as follows. A 1 L cylindrical flask was equipped with a stirring rod. The flask was loaded with 200 g of 25 wt % acrylonitrile butadiene based natural rubber (N-34, available from Nippon Zeon Co. Ltd., Japan) dissolved in toluene, 110 g of 50 wt % fluorene type epoxy resin (BPEFG, available from Osaka Gas Co. Ltd., Japan, Mw: 500 or less) dissolved in toluene, 10 g of conductive particles (available from NCI) having a diameter of 4 μm and having benzoguanine polymer particles coated with nickel and gold, 5 g of methylethylketone peroxide (available from Hosung Chemex, Korea), and 1 g of 3-methacryloxy propyltriethoxysilane as a radical polymerization silane coupling agent. Then, the mixture was stirred at room temperature (25° C.) for 20 min.

Then, 2-methacryloyloxyethylphosphate, 7 g of 2-hydroxyethylmethacryloyloxyethylphosphate, 50 g of difunctional isocyanourate type acrylate (M-215, available from Toagosei Co. Ltd., Japan), and 100 g of urethane acrylate (UA-512, available from Shin-Nakamura Chemical Co. Ltd., Japan), serving as a radical polymerizable acrylate monomer, 0.2 g of hydroquinone monomethylether as a polymerization inhibitor, and 100 g of propyleneglycol monomethyl ether acetate as a solvent were added. The mixture was stirred at room temperature (25° C.) for 30 min, to prepare a cover film composition C.

Subsequently, the composition B was applied in a thickness of 10 μm onto a 50 μm-thick white PET type base film. The composition C was applied in the same thickness onto a 30μm-thick transparent PET type cover film. The resulting films were attached to each other, and were laminated.

### COMPARATIVE EXAMPLE 1

A conductive film was prepared in the same manner as in Example 1 with the exception that manganese naphthenate was not added when preparing a base film composition.

### COMPARATIVE EXAMPLE 2

A conductive film was prepared in the same manner as in Example 2 with the exception that copper naphthenate and organic catalyst were not added when preparing a base film composition.

### COMPARATIVE EXAMPLE 3

A conductive film was prepared in the same manner as in Example 3 with the exception that cobalt naphthenate and organic catalyst were not added when preparing a base film composition.

Physical Properties of Anisotropic Conductive Film

Physical properties of the anisotropic conductive films of Examples 1 to 3 and Comparative Examples 1 to 3 were analyzed as follows. The results are given in Table 1 below.

(1) Peel Strength: Each film was allowed to stand at room temperature (25° C.) for 1 hr, after which 90° peel strength was measured using an indium tin oxide (ITO) glass having a size of 30 mm×30 mm and a chip-on-film tape having a pitch of 55 μm, a thickness of 12 μm, and a line of 25 μm and space width of 30 μm.

(2) Electrical Contact Resistance: Samples, each of which consists of 10 pieces, were measured using an ITO having the same size as the above an ITO and a TCP (tape carrier package) tape-having a pitch of 65 μm, a thickness of 18 μm, and a line of 30 μm and space width of 35 μm. The samples were pressed at 160° C. for 1 sec (as a pre-bonding process). Then, they were cured at 175° C. for 4 sec (Example 1 and Comparative Example 1), 165° C. for 4 sec (Example 2 and Comparative Example 2), and 155° C. for 4 sec (Example 3 and Comparative Example 3), under a pressure of 3 MPa.

(3) Residual Curing Rate: Resulting anisotropic conductive films were evaluated using a DSC (Differential Scanning Calorimeter).

TABLE 1

| | Peel Strength | Electrical Contact | Residual Curing Rate |
|---|---|---|---|
| Properties | (gf/cm) | Resistance (Ω) | (%) |
| Ex. 1 | 832 | 0.73 | 100 − 75 = 25 |
| Ex. 2 | 763 | 0.92 | 100 − 83 = 17 |
| Ex. 3 | 892 | 1.02 | 100 − 84 = 16 |
| C. Ex. 1 | 532 | 1.40 | 100 − 45 = 55 |
| C. Ex. 2 | 587 | 1.51 | 100 − 61 = 39 |
| C. Ex. 3 | 394 | 2.64 | 100 − 60 = 40 |

As shown in Table 1, each of the films of Examples 1 to 3 exhibited a higher peel strength, a lower electrical contact resistance, and a lower residual curing rate than those of Comparative Examples 1 to 3 under the same curing conditions. This is because the multivalent metal ions activated a peroxide polymerization initiator during the bonding or curing process.

As described above, the circuit connecting films of the embodiments provide high curing rates even at a low temperature. Therefore, the circuit connecting films allow high productivity on assembling electronic parts while preventing thermal deformation of a bonding machine due to a high temperature process. In addition, a resulting anisotropic conductive film has a high peel strength and a low electrical contact resistance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A circuit connecting material, comprising:
a body-forming resin;
a polymerizable compound;
a plurality of conductive particles;
a peroxide polymerization initiator; and
a transition metal.

2. The material of claim 1, wherein the transition metal comprises one or more selected from the group consisting of Ag, Co, Cr, Cu, Fe, Mo, Mn, Nb, Ni, Os, Pd, Rh, Ru, Sn, Ti, V, Y and Zn.

3. The material of claim 1, wherein the transition metal is in at least one form selected from the group consisting of a salt, an ionic and a metal-ligand form.

4. The material of claim 1, further comprising at least one transition-metal-containing compound selected from the group consisting of an oxide, an octate, a naphthenate, a halide, an acetylacetonate, a sulfate, a nitrate and a hydrate of a transition metal.

5. The material of claim 1, wherein the transition metal is in an amount of between about 0.001 wt % and about 10 wt % with reference to the total weight of the material.

6. The material of claim 1, wherein the peroxide polymerization initiator comprises a ketone peroxide.

7. The material of claim 1, wherein the transition metal activates the peroxide polymerization initiator.

8. The material of claim 1, further comprising an organic catalyst for controlling the polymerization rate of the polymerizable compound.

9. The material of claim 8, wherein the organic catalyst comprises one or more selected from the group consisting of dimethylaniline, t-butylperoxy-2-ethylhexanoate, bis(4-t-butylcyclohexyl)peroxydicarbonate, nonylphenol, t-butylperbenzoate and quaternary ammonium.

10. The material of claim 1, wherein the material is shaped in a film.

11. The material of claim 10, wherein the film is rolled into a reel.

12. The material of claim 1, further comprising an organic solvent, which dissolves at least part of the material, wherein the material is in a liquid or a slurry form.

13. A circuit connecting material, comprising:
a first layer comprising a transition metal, the first layer having a first surface; and
a second layer formed on and in contact with the first surface, the second layer comprising a polymerization initiator,
wherein at least one of the first and second layers further comprises at least one of a body-forming resin and conductive particles.

14. The material of claim 13, wherein the first layer is substantially free of a polymerization initiator.

15. The material of claim 13 wherein the first layer further comprises a polymerization initiator in an amount substantially smaller than the polymerization initiator in the second layer.

16. The material of claim 15, wherein the second layer comprises the polymerization initiator more than the first layer at least by 20 wt % of the polymerization initiator contained in the first layer.

17. The material of claim 13, wherein the second layer is substantially free of a transition metal.

18. The material of claim 13, wherein the second layer further comprises a transition metal in an amount substantially smaller than the transition metal in the first layer.

19. The material of claim 18, wherein the first layer comprises the transition metal more than the second layer at least by 20 wt % of the transition metal contained in the second layer.

20. The material of claim 13, wherein the first layer comprises at least one of the body-forming resin and the conductive particles.

21. The material of claim 13, wherein the second layer comprises at least one of the body-forming resin and the conductive particles.

22. The material of claim 13, wherein each of the first and the second layers comprises the body-forming resin and conductive particles.

23. The material of claim 13, wherein the second layer has a second surface facing away from the first layer, wherein the material further comprises a third layer formed on and in contact with the second surface, and wherein the third layer comprises a transition metal.

24. The material of claim 13, wherein the first layer has a second surface facing away from the second layer, wherein the material further comprises a third layer formed on and in contact with the second surface, and wherein the third layer comprises a polymerization initiator.

25. A method of making an electronic device, the method comprising:
providing an intermediate product of an electronic device, the intermediate product comprising first and second electrically conductive portions;
placing the circuit connecting material of claim 1 between the first and second electrically conductive portions;
anisotropically aligning at least some conductive particles between the first and second electrically conductive portions; and
polymerizing at least part of the polymerizable compounds of the circuit connecting material,
wherein the transition metal activates the peroxide polymerization initiator to initiate polymerization of the polymerizable compounds.

26. The method of claim 25, wherein prior to placing the circuit connecting material, the circuit connecting material is maintained at a temperature of less than about 5° C.

27. The method of claim 25, further comprising heating the circuit connecting material to a temperature from about 80° C. to about 200° C. after placing the circuit connecting material.

28. The method of claim 25, wherein anisotropically aligning comprises pressuring the circuit connecting material between the first and second electrically conductive portions.

29. An electronic device made by the method of claim 25, wherein the circuit connecting material is bonded to both the first and second electrically conductive portions and electrically connects between the first and second conductive portions.

30. An electronic device comprising:
a first circuit;
a second circuit; and
an anisotropic conductive film made from the circuit connecting material of claim 13.

31. An electronic device comprising:
a first circuit;
a second circuit, and
an anisotropic conductive film interconnecting the first and second circuits, the anisotropic conductive film comprising at least one anisotropic conductive connection between the first and second circuits, a cross-linked polymer resin, a transition metal, and a peroxide polymerization initiator.

32. The electronic device of claim 31, wherein the anisotropic conductive film further comprises one or more compounds derived from the peroxide polymerization initiator.

33. The electronic device of claim 31, wherein the transition metal is generally homogeneously distributed in the anisotropic conductive film.

34. The electronic device of claim 31, wherein the transition metal is non-homogeneously distributed in the anisotropic conductive film.

35. The electronic device of claim 34, wherein the anisotropic conductive film comprises first and second layer-like portions, each of the layer-like portions extend generally perpendicular to a direction of the anisotropic conductive connection.

36. The electronic device of claim 35, wherein the first layer-like portion has substantially more transition metal than the second layer-like portion.

37. The electronic device of claim 35, wherein the second layer-like portion has substantially more peroxide polymerization initiator residue than the first layer-like portion.
